(19) United States
(12) Patent Application Publication
(10) Pub. No.: US 2008/0152462 A1
(43) Pub. Date: Jun. 26, 2008

(54) LOCATING MECHANISM OF FOLDING CAMP TABLE

(76) Inventor: HUI CHEN, Xiamen (CN)

Correspondence Address: Dr. BANGER SHIA, 102 Lindencrest Ct., Sugar Land, TX, 77479-5201, US

(21) Appl. No.: 11/616,008

(22) Filed: Dec. 25, 2006

(51) Int. Cl. F16B 37/08

(52) U.S. Cl. 411/433

(57) ABSTRACT

The present invention provides a locating mechanism of folding camp table including a pair of matched screw bolt and nut both installed on the main prop; wherein said screw bolt is built on the top-side of the low pivoting hub so that the screw bolt and the low pivoting hub are fit on the low portion of the main prop in moving connection, said nut is fit on the main prop in sliding connection, between said nut and said low pivoting hub, a limit device is attached on the stem of the main prop for limiting the nut sliding down, by screwing the nut, securing the nut on screw bolt attached on the low pivoting hub locates the table in extended state. As operating on this structure, just need one hand, more convenient and more human-based.

### BACKGROUND OF THE INVENTION

1. Field of the Invention

The present invention relates to a foldable table, and more particularly to a locating mechanism of folding camp table.

2. Description of Prior Art

In accordance with the conventional folding camp tables in the market so far, the structure of them, as shown in FIG. 1, typically is that all the corner struts 8 bracing the corners of the table surface cloth 10 up with the upper ends are collectedly pivoted on a low pivoting hub 6 with the low ends of them, and all the landing legs 9 standing on the ground at the low ends are pivoted on an upper pivoting hub 7 via connecting link 11 respectively (or directly pivoted on with the upper ends), said upper pivoting hub 7 is fixed on the top end of a main prop 4, and the low end of the prop 4 is fit into the low pivoting hub 6 movably, the foldable framework also can be in other structure similar to FIG. 1, but the locating function is carried out by a knob 2 having a screw bolt 1 and a nut 3, as shown in FIG. 2, said nut is fixed on the main prop 4 by a rivet 5, said knob 2 attached with the screw bolt 1 is fit into the inside of said low pivoting hub 6 in rotary connection, of course the low end of the main prop 4 passes through the through-hole of the screw bolt 1.

When tending to spread the folding camp table applying above-mentioned structure, the user needs to hold the nut 3 with one hand, and the another hand should hold the knob 2 having the screw bolt 1 to aim at them each other overcoming the weights of the knob 2 and the low pivoting hub 6 until the low pivoting hub 6 droved to move up along the stem of the main prop 4 to brace the table surface cloth up completely via all the linking pieces including the connecting links 11 and the landing legs 9 simultaneously, by means of the secure-in of the screw bolt 1 and the nut 3, all the linking pieces including the corner struts 8, the connecting links 11 and the landing legs 9 are located, so the camp table has been spread out and located.

But operating a folding camp table with this kind of locating mechanism should not only overcome the weight and propping force including pushing the low pivoting hub 6 up, spreading the table surface cloth out and standing on the table on the ground via all the linking pieces connected on the low pivoting hub 6, but also do a screwing upward action, therefore, the opening and locating operation is hard to the user. Especially as locating, the user has to bend and stretch the body under the opened table to aim the knob 2 to the nut 3, then carry out screw-in operation, or in another way, turn the opened table upside down firstly, then carry out screw-in operation for locating the table in spread state, finally turn the located table back. On the other hand, because said low pivoting hub 6 is connected to the knob 2 in socket joint, the locating mechanism exists following shortcomings: more assembling components, high manufacture cost, occupying both hands in operation, bending body during operation, more labors needed, and inconvenience.

### OBJECTS AND SUMMARY OF THE INVENTION

It is therefore a main object of the present invention to provide a locating mechanism for folding camp table having facilitating to operation and human-based features.

The second object of the present invention is to provide a locating mechanism of folding camp table using fewer parts, and less manufacture cost.

For achieving the above-mentioned objects, the present invention provides a locating mechanism, which including a pair of matched screw bolt and nut both installed on the main prop; wherein said screw bolt is built on the top-side of the low pivoting hub so that the screw bolt and the low pivoting hub are fit on the low portion of the main prop in moving connection, said nut is fit on the main prop in sliding connection, between said nut and said low pivoting hub, a limit device is attached on the stem of the main prop for limiting the nut sliding down, by screwing the nut, securing the nut on screw bolt attached on the low pivoting hub locates the table in extended state.

Said screw bolt is molded on the low pivoting hub in one body.

Said limit device is a sleeve fixed on the main prop.

As utilizing above-mentioned project, due to said screw bolt integrated into the low pivoting hub, the structure employs fewer parts, and less manufacture cost, and facilitate to operation, as tending to spreading the folding camp table, the user just need to press down the nut with one hand, the folding camp table can be spread out, meanwhile the nut sliding down can aim to the screw bolt automatically along with the stem of the main prop, finally screw it on at all.

### BRIEF DESCRIPTION OF THE DRAWINGS

FIG. 1 is a perspective view of the prior art.

FIG. 2 is a perspective view showing the locating mechanism of the prior art.

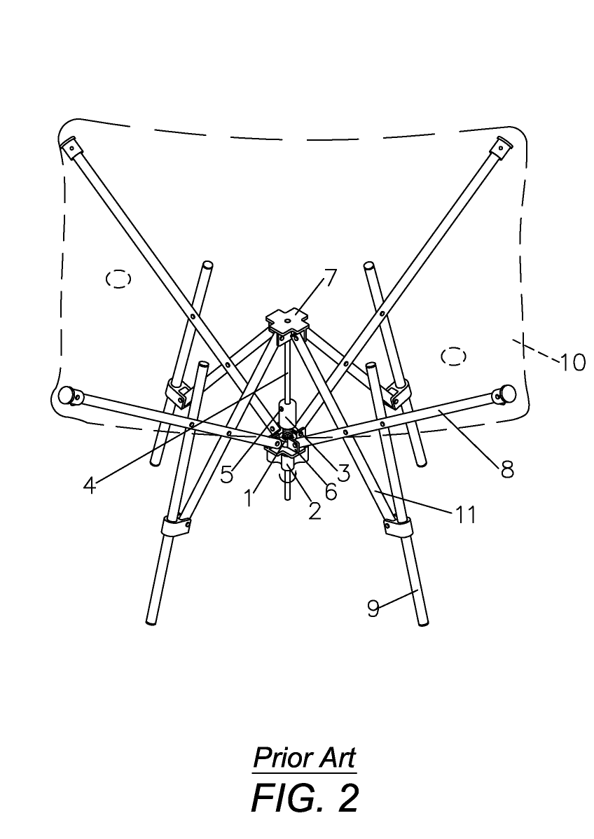

FIG. 3 is a perspective view of the present invention.

FIG. 4 is a perspective view showing the un-location state of the present invention.

FIG. 5 is a perspective view showing the location state of the present invention.

### DETAILED DESCRIPTION OF PREFERRED EMBODIMENTS

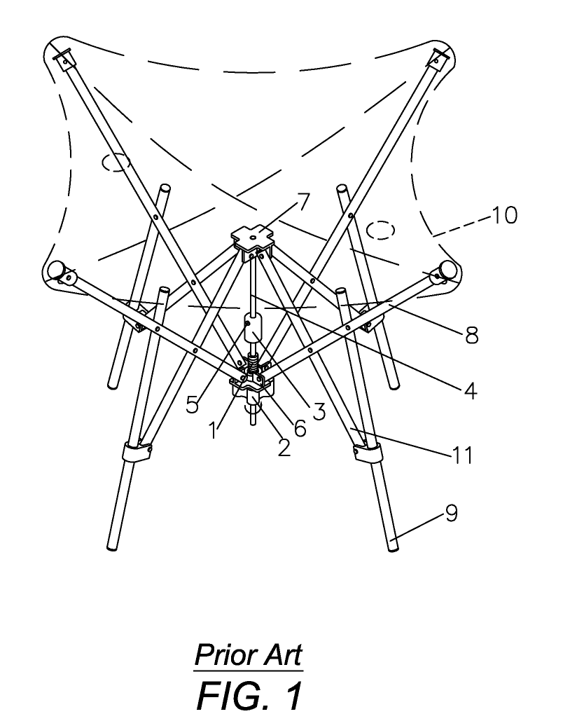

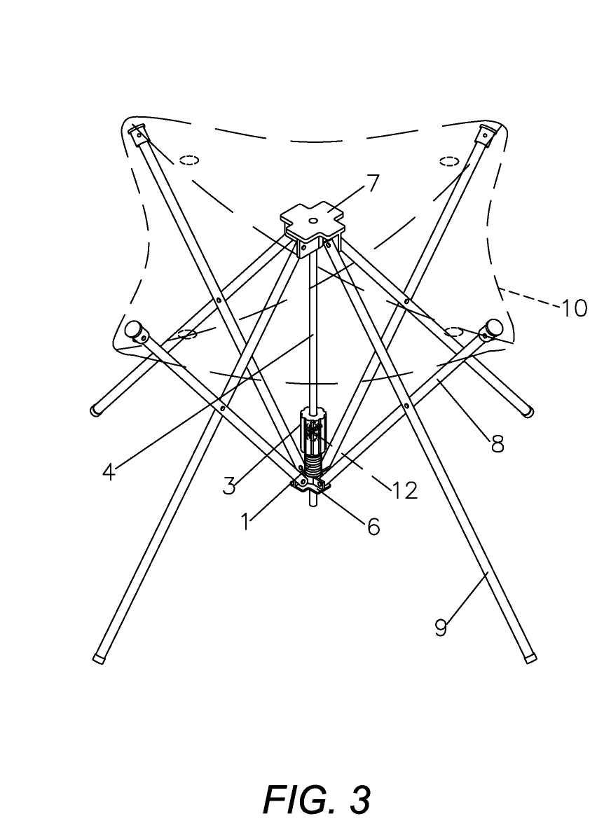

A folding camp table provided by the present invention, as shown in FIG. 3, is similar as the above-mentioned prior art, as shown in FIG. 1, in foldable structure, the difference is just on that said all landing legs 9 are pivoted on the upper pivoting hub 7 directly, all the foldable structure is not the key point of the present invention, so all the part numbers and description are referred to above-described and FIG. 1.

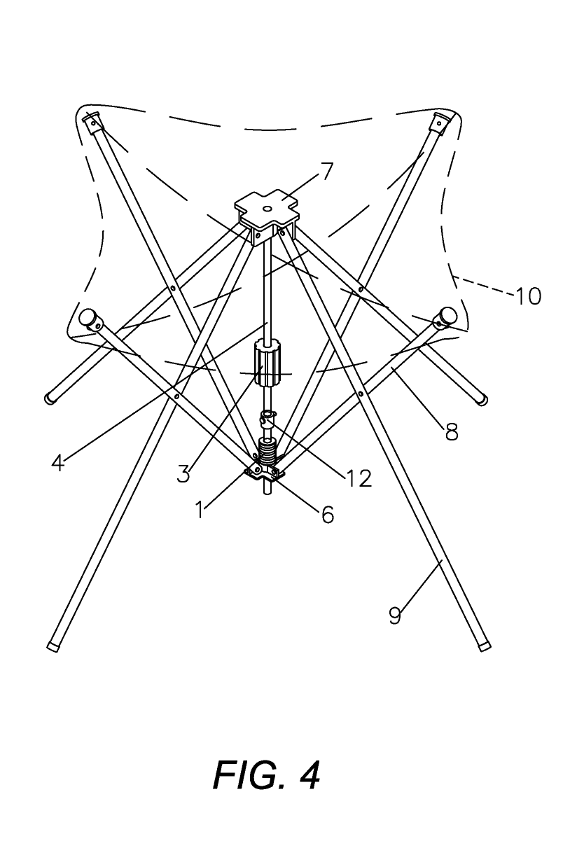

Referring to FIG. 4, a locating mechanism discovered by the present invention is typically comprised of a pair of mated screw bolt 1 and nut 3 both installed on the main prop 4. Wherein said screw bolt 1 is built on the top-side of the low pivoting hub 6, in this embodiment both of them can be molded into one body for decreasing the amount of the parts and manufacture cost, in the other way, they also can be molded in individual, then assembled into an assembly, so that the screw bolt 1 and the low pivoting hub 6 are fit on the low portion of the main prop in moving connection. Said nut 3 is fit on the main prop 4 in sliding connection for securing operation between said nut 3 and said low pivoting hub 6, a limit device is attached on the stem of the main prop 4 for limiting the nut 3 sliding down, and defining the distance between the upper pivoting hub 7 and the low pivoting hub 6 in location state, said limit device is a sleeve 12 fixed on the main prop 4 in this embodiment.

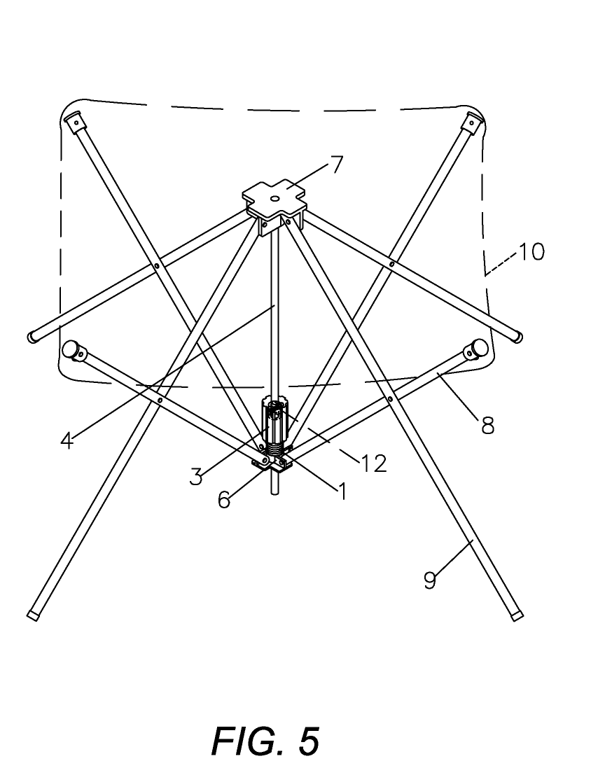

As tending to spreading the folding camp table, as shown in FIG. 5, the user just need to press down the nut 3 with one hand, the folding camp table can be spread out, meanwhile the nut 3 sliding down can aim to the screw bolt 1 automatically along with the stem of the main prop 4, finally screw it on locating said low pivoting hub 6 on the pre-set distance from the upper pivoting hub 7, in this time, all the linking pieces including the corner struts 8 and the landing legs 9 are located on fully extended state, and the table surface cloth is spread out for use.

Comparing with the prior art, the present invention employs the locating mechanism spreading out the table as aiming to the screw bolt 1 for securing location instead of the conventional pushing up the low pivoting hub 6 overcoming the weight and propping force of all the table as aim to the screw bolt 1 as making securing location, so all the operation just needs one hand at all, more convenient and more human-based.

I claim:

1. A locating mechanism of folding camp table including a pair of matched screw bolt and nut both installed on the main prop; wherein said screw bolt is built on the top-side of the low pivoting hub so that the screw bolt and the low pivoting hub are fit on the low portion of the main prop in moving connection, said nut is fit on the main prop in sliding connection, between said nut and said low pivoting hub, a limit device is attached on the stem of the main prop for limiting the nut sliding down, by screwing the nut, securing the nut on screw bolt attached on the low pivoting hub locates the table in extended state.

2. A locating mechanism of folding camp table as claimed in claim 1, wherein said screw bolt is molded on the low pivoting hub in one body.

3. A locating mechanism of folding camp table as claimed in claim 1, wherein said limit device is a sleeve fixed on the main prop.
